(19) United States
(12) Patent Application Publication
(10) Pub. No.: US 2022/0274305 A1
(43) Pub. Date: Sep. 1, 2022

(54) INJECTION MOLDING MACHINE AND CONTROLLER

(71) Applicant: SUMITOMO HEAVY INDUSTRIES, LTD., Tokyo (JP)

(72) Inventors: Kazuki Tanida, Chiba (JP); Hiroshi Mogi, Kanagawa (JP); Mikio Arita, Kanagawa (JP)

(21) Appl. No.: 17/746,568

(22) Filed: May 17, 2022

Related U.S. Application Data
(63) Continuation of application No. PCT/JP2020/042654, filed on Nov. 16, 2020.

(30) Foreign Application Priority Data
Nov. 18, 2019 (JP) 2019-207924

(51) Int. Cl. B29C 45/76

(52) U.S. Cl. CPC B29C 45/762; B29C 2945/76066; B29C 2945/76163; B29C 2945/76973; B29C 2945/76993

(57) ABSTRACT

An injection molding machine includes a mold clamping unit that clamps a mold unit, an injection unit that fills the mold unit clamped by the mold clamping unit with a molding material, and an ejector unit that takes out a molding product from the mold unit after the molding material with which the mold unit is filled by the injection unit is cooled and solidified, in which a communication cycle in which data is exchanged in at least one path of between two internal devices and between the injection molding machine and an external device is shorter than a control cycle in which predetermined control is performed using received data.

### RELATED APPLICATIONS

The contents of Japanese Patent Application No. 2019-207924, and of International Patent Application No. PCT/JP2020/042654, on the basis of each of which priority benefits are claimed in an accompanying application data sheet, are in their entirety incorporated herein by reference.

### BACKGROUND

### Technical Field

Certain embodiments of the present invention relate to an injection molding machine and the like.

### Description of Related Art

In a control system, output data may be transmitted from one side to the other side, and control may be performed using data received by the other.

For example, in an industrial machine such as an injection molding machine, data output by various sensors is transmitted to a controller, and data received by the controller is used for controlling a molding operation or the like (refer to related art).

### SUMMARY

According to an embodiment of the present disclosure, in order to achieve the above-described object, there is provided an injection molding machine including a mold clamping unit that clamps a mold unit, an injection unit that fills the mold unit clamped by the mold clamping unit with a molding material, and an ejector unit that takes out a molding product from the mold unit after the molding material with which the mold unit is filled by the injection unit is cooled and solidified. A communication cycle in which data is exchanged in at least one path of between internal devices and between the injection molding machine and an external device is shorter than a control cycle in which predetermined control is performed using received data.

In addition, according to another embodiment of the present disclosure, there is provided an injection molding machine including a mold clamping unit that clamps a mold unit, an injection unit that fills the mold unit clamped by the mold clamping unit with a molding material, and an ejector unit that takes out a molding product from the mold unit after the molding material with which the mold unit is filled by the injection unit is cooled and solidified. In a case where data is exchanged in at least one path of between internal devices and between the injection molding machine and an external device, and predetermined control is performed using received data, even when there is a failure in receiving the data, the latest data is capable of being used.

In addition, according to still another embodiment of the present disclosure, there is provided a controller in which a communication cycle in which data is exchanged in at least one path of between internal CPUs and between the injection molding machine and another device is shorter than a control cycle in which predetermined control is performed using received data.

### BRIEF DESCRIPTION OF THE DRAWINGS

FIG. 1A is a diagram illustrating an example of a configuration of an injection molding machine management system including an injection molding machine.

FIG. 1B is a diagram illustrating an example of a configuration of the injection molding machine management system including the injection molding machine.

FIG. 2 is a diagram illustrating an example of a configuration of a controller.

FIG. 3A is a diagram illustrating an example of an operation of the controller.

FIG. 3B is a diagram illustrating an example of an operation of the controller.

FIG. 4A is a diagram illustrating another example of an operation of the controller.

FIG. 4B is a diagram illustrating another example of an operation of the controller.

FIG. 5 is a diagram illustrating an example of a cycle setting screen displayed on a display unit.

### DETAILED DESCRIPTION

However, in a case where the data cannot be received for any reason such as a communication failure, there is a possibility that the latest data may not be available.

Therefore, it is desirable to provide a technique capable of performing control using the latest data in an injection molding machine or the like even in a case where data cannot be received for any reason.

Hereinafter, an embodiment will be described with reference to the drawings.

### Configuration of Injection Molding Machine Management System

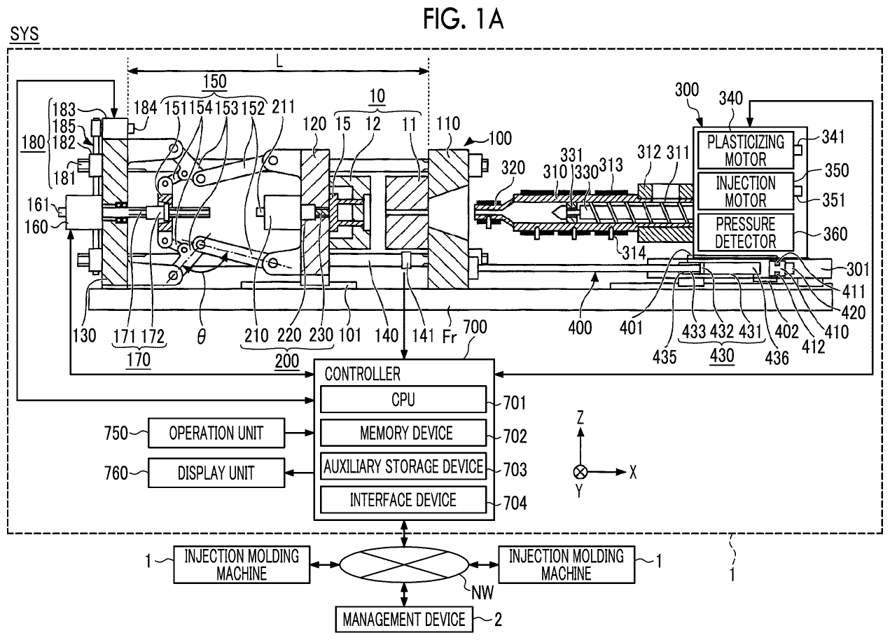

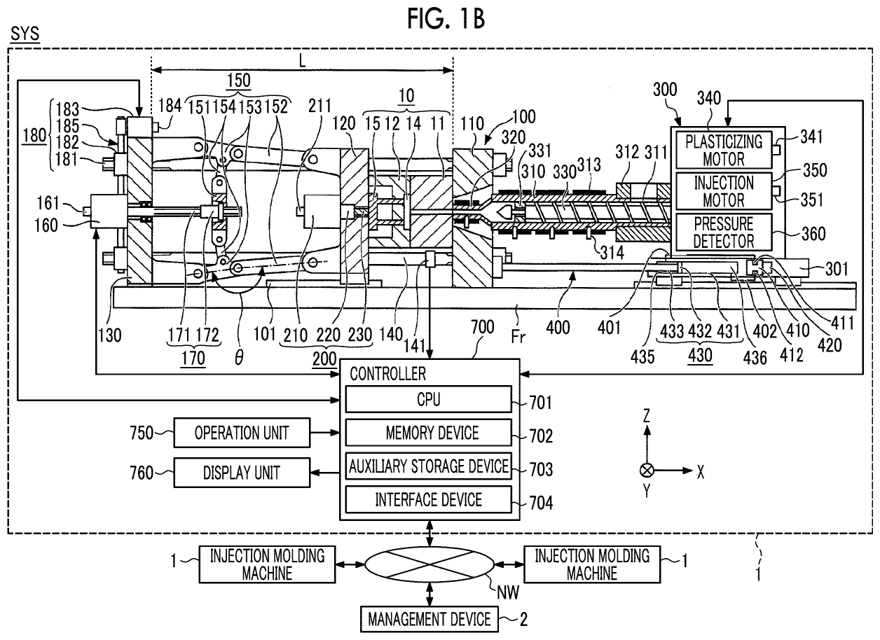

First, with reference to FIG. 1 (FIGS. 1A and 1B), a configuration of an injection molding machine management system SYS according to the present embodiment will be described.

FIGS. 1A and 1B are diagrams illustrating an example of the injection molding machine management system SYS according to the present embodiment. Specifically, in FIG. 1A, a side sectional view illustrating a state when a mold opening of an injection molding machine 1 is completed is drawn. In FIG. 1B, a side sectional view illustrating a state of the injection molding machine 1 at the time of mold clamping is drawn. Hereinafter, in the drawings of the present embodiment, an X-axis, a Y-axis, and a Z-axis are perpendicular to each other. Positive and negative directions of the X-axis (hereinafter, simply “X-direction”) and positive and negative directions of the Y-axis (hereinafter, simply “Y-direction”) represent a horizontal direction, and positive and negative directions of the Z-axis (hereinafter, simply “Z-direction”) represent a vertical direction.

The injection molding machine management system SYS includes a plurality (three in the present example) of injection molding machines 1 and a management device 2.

The number of injection molding machines 1 included in the injection molding machine management system SYS may be one.

### Injection Molding Machine

The injection molding machine 1 performs a series of operations for obtaining a molding product.

In addition, the injection molding machine 1 is communicably connected to the management device 2 through a predetermined communication line NW. In addition, the injection molding machine 1 may be communicably connected to the other injection molding machine 1 through the communication line NW. For example, the communication line NW may include a wide area network (WAN) outside a factory where the injection molding machine 1 is installed. For example, the wide area network may include a mobile communication network having a base station as a terminal. For example, the mobile communication network may support 4th generation (4G) or 5th generation (5G) including long term evolution (LTE). In addition, the wide area network may include, for example, a satellite communication network that uses a communication satellite. In addition, the wide area network may include, for example, an Internet network. In addition, for example, the communication line NW may include a local network (local area network: LAN) inside a factory where the injection molding machine 1 is installed. The local network may be constructed wired, wireless, or in a manner including both wired and wireless. In addition, the communication line NW may include, for example, a short-range wireless communication line corresponding to Bluetooth (registered trademark) communication or WiFi communication.

In addition, the injection molding machine 1 transmits (uploads) data relating to the operation state of the injection molding machine 1 (hereinafter, “operation state data”) to the management device 2 (an example of a predetermined external device) through the communication line NW. In this manner, the management device 2 (or a manager or a worker thereof) can identify the operation state, and can manage a maintenance time of the injection molding machine 1 or an operation schedule of the injection molding machine 1.

In addition, for example, the injection molding machine 1 as a master machine may monitor or control an operation of the other injection molding machine 1 as a slave machine through the communication line NW. Specifically, the injection molding machine 1 (slave machine) may transmit operation state data to the injection molding machine 1 (master machine) through the communication line NW. In this manner, the injection molding machine 1 (master machine) can monitor the operation of the other injection molding machine 1 (slave machine). In addition, the injection molding machine 1 (master machine) may transmit a control command relating to the operation to the other injection molding machine 1 (slave machine) through the communication line NW while identifying the operation state of the other injection molding machine 1 (slave machine) based on the operation state data. In this manner, the injection molding machine 1 (master machine) can control the operation of the other injection molding machine 1 (slave machine).

The injection molding machine 1 (example of a predetermined machine) includes a mold clamping unit 100, an ejector unit 200, an injection unit 300, a moving unit 400, and a controller 700.

### Mold Clamping Unit

The mold clamping unit 100 performs mold closing, mold clamping, and mold opening of the mold unit 10. For example, the mold clamping unit 100 is a horizontal type, and a mold opening and closing direction is a horizontal direction. The mold clamping unit 100 has a stationary platen 110, a movable platen 120, a toggle support 130, a tie bar 140, a toggle mechanism 150, a mold clamping motor 160, a motion conversion mechanism 170, and a mold space adjustment mechanism 180.

Hereinafter, in describing the mold clamping unit 100, a moving direction of the movable platen 120 during mold closing (rightward direction in FIGS. 1A and 1B) will be defined as forward, and a moving direction of the movable platen 120 during mold opening (leftward direction in FIGS. 1A and 1B) will be defined as rearward.

The stationary platen 110 is fixed to a frame Fr. A stationary mold 11 is attached to a surface of the stationary platen 110 which faces the movable platen 120.

The movable platen 120 is movable with respect to the frame Fr in the mold opening and closing direction. A guide 101 that guides the movable platen 120 is laid on the frame Fr. The movable mold 12 is attached to a surface of the movable platen 120 which faces the stationary platen 110.

Since the movable platen 120 is advanced and retreated with respect to the stationary platen 110, the mold closing, the mold clamping, and the mold opening are performed.

The mold unit 10 includes the stationary mold 11 corresponding to the stationary platen 110 and a movable mold 12 corresponding to the movable platen 120.

The toggle support 130 is connected to the stationary platen 110 at a predetermined interval L, and is mounted on the frame Fr to be movable in the mold opening and closing direction. For example, the toggle support 130 may be movable along a guide laid on the frame Fr. In this case, a guide of the toggle support 130 may be common to the guide 101 of the movable platen 120.

The stationary platen 110 is fixed to the frame Fr, and the toggle support 130 is movable with respect to the frame Fr in the mold opening and closing direction. However, the toggle support 130 may be fixed to the frame Fr, and the stationary platen 110 may be movable with respect to the frame Fr in the mold opening and closing direction.

The tie bar 140 connects the stationary platen 110 and the toggle support 130 to each other at an interval L in the mold opening and closing direction. A plurality of (for example, four) tie bars 140 may be used. Each of the tie bars 140 is disposed parallel to the mold opening and closing direction, and extends depending on a mold clamping force. At least one of the tie bars 140 is provided with a tie bar strain detector 141 that detects a strain of the tie bar 140. The tie bar strain detector 141 is, for example, a strain gauge. The tie bar strain detector 141 transmits a signal indicating a detection result thereof to the controller 700. The detection result of the tie bar strain detector 141 is used, for example, for detecting the mold clamping force.

Instead of or in addition to the tie bar strain detector 141, any mold clamping force detector that can be used to detect the mold clamping force may be used. For example, the mold clamping force detector is not limited to a strain gauge type, and may be a piezoelectric type, a capacitive type, a hydraulic type, or an electromagnetic type. An attachment position thereof is not limited to the tie bar 140.

The toggle mechanism 150 is disposed between the movable platen 120 and the toggle support 130, and moves the movable platen 120 with respect to the toggle support 130 in the mold opening and closing direction. The toggle mechanism 150 is configured to include a crosshead 151 and a pair of link groups. Each of the link groups has a first link 152 and a second link 153 which are flexibly connected by a pin. The first link 152 is oscillatingly attached to the movable platen 120 by a pin, and the second link 153 is oscillatingly attached to the toggle support 130 by a pin. The second link 153 is attached to the crosshead 151 via a third link 154. When the crosshead 151 is advanced and retreated with respect to the toggle support 130, the first link 152 and the second link 153 are bent and stretched so that the movable platen 120 is advanced and retreated with respect to the toggle support 130.

A configuration of the toggle mechanism 150 is not limited to a configuration illustrated in FIGS. 1A and 1B. For example, in FIGS. 1A and 1B, the number of nodes in each of the link groups is five, but may be four. One end portion of the third link 154 may be coupled to the node between the first link 152 and the second link 153.

The mold clamping motor 160 is attached to the toggle support 130, and operates the toggle mechanism 150. The mold clamping motor 160 advances and retreats the crosshead 151 with respect to the toggle support 130. In this manner, the first link 152 and second link 153 are bent and stretched so that the movable platen 120 is advanced and retreated with respect to the toggle support 130. The mold clamping motor 160 is directly connected to the motion conversion mechanism 170, but may be connected to the motion conversion mechanism 170 via a belt or a pulley.

The motion conversion mechanism 170 converts a rotary motion of the mold clamping motor 160 into a linear motion of the crosshead 151. The motion conversion mechanism 170 includes a screw shaft 171 and a screw nut 172 screwed to the screw shaft 171. A ball or a roller may be interposed between the screw shaft 171 and the screw nut 172.

The mold clamping unit 100 performs a mold closing process, a mold clamping process, and a mold opening process under the control of the controller 700.

In the mold closing process, the mold clamping motor 160 is driven to advance the movable platen 120 by advancing the crosshead 151 to a mold closing completion position at a set speed. In this manner, the movable mold 12 is caused to touch the stationary mold 11. For example, a position or a speed of the crosshead 151 is detected by using a mold clamping motor encoder 161. The mold clamping motor encoder 161 detects rotation of the mold clamping motor 160, and transmits a signal indicating a detection result thereof to the controller 700.

A crosshead position detector for detecting the position of the crosshead 151 and a crosshead speed detector for measuring the speed of the crosshead 151 are not limited to the mold clamping motor encoder 161, and a general detector can be used. In addition, a movable platen position detector for detecting the position of the movable platen 120 and a movable platen speed detector for measuring the speed of the movable platen 120 are not limited to the mold clamping motor encoder 161, and a general detector can be used.

In the mold clamping process, the mold clamping motor 160 is further driven to further advance the crosshead 151 from the mold closing completion position to a mold clamping position, thereby generating a mold clamping force. During the mold clamping, a cavity space 14 is formed between the movable mold 12 and the stationary mold 11, and the injection unit 300 fills the cavity space 14 with a liquid molding material. A molding product is obtained by solidifying the molding material filled therein. The number of the cavity spaces 14 may be two or more. In this case, a plurality of the molding products can be obtained at the same time.

In the mold opening process, the mold clamping motor 160 is driven to retreat the movable platen 120 by retreating the crosshead 151 to the mold opening completion position at a set speed, so that the movable mold 12 is separated from the stationary mold 11. Thereafter, the ejector unit 200 ejects the molding product from the movable mold 12.

Setting conditions in the mold closing process and the mold clamping process are collectively set as a series of setting conditions. For example, the speed or the position of the crosshead 151 (including a mold closing start position, a speed switching position, a mold closing completion position, and a mold clamping position) and the mold clamping force in the mold closing process and the mold clamping process are collectively set as a series of setting conditions. The mold closing start position, the speed switching position, the mold closing completion position, and the mold clamping position are aligned in this order from a rear side toward a front side, and represent a start point and an end point of a section in which the speed is set. The speed is set for each section. The number of the speed switching positions may be one or more. The speed switching position may not be set. Only one of the mold clamping position and the mold clamping force may be set.

In addition, the setting conditions in the mold opening process are set in the same manner. For example, the speed or the position (including the mold opening start position, the speed switching position, and the mold opening completion position) of the crosshead 151 in the mold opening process are collectively set as a series of setting conditions. The mold opening start position, the speed switching position, and the mold opening completion position are aligned in this order from the front side toward the rear side, and represent the start point and the end point of the section in which the speed is set. The speed is set for each section. The number of the speed switching positions may be one or more. The speed switching position may not be set. The mold opening start position and the mold clamping position may be the same position. In addition, the mold opening completion position and the mold closing start position may be the same position.

Instead of the speed or the position of the crosshead 151, the speed or the position of the movable platen 120 may be set. In addition, instead of the position (for example, the mold clamping position) of the crosshead or the position of the movable platen, the mold clamping force may be set.

The toggle mechanism 150 amplifies a driving force of the mold clamping motor 160, and transmits the driving force to the movable platen 120. An amplification magnification is referred to as a toggle magnification. The toggle magnification is changed depending on an angle θ (hereinafter, “link angle θ”) formed by the first link 152 and the second link 153. The link angle θ is obtained from the position of the crosshead 151. When the link angle θ is 180°, the toggle magnification is maximized.

In a case where a thickness of the mold unit 10 is changed due to replacement of the mold unit 10 or a temperature change in the mold unit 10, a mold space is adjusted so that a predetermined mold clamping force is obtained during the mold clamping. For example, in the mold space adjustment, an interval L between the stationary platen 110 and the toggle support 130 is adjusted so that the link angle θ of the toggle mechanism 150 becomes a predetermined angle at the time of mold touch when the movable mold 12 touches the stationary mold 11.

The mold clamping unit 100 has the mold space adjustment mechanism 180 that adjusts a mold space by adjusting the interval L between the stationary platen 110 and the toggle support 130. The mold space adjustment mechanism 180 has a screw shaft 181 formed in a rear end portion of the tie bar 140, a screw nut 182 held to be rotatable by the toggle support 130, and a mold space adjustment motor 183 that rotates the screw nut 182 screwed to the screw shaft 181.

The screw shaft 181 and the screw nut 182 are provided for each of the tie bars 140. The rotation of the mold space adjustment motor 183 may be transmitted to a plurality of the screw nuts 182 via a rotation transmission part 185. The plurality of screw nuts 182 can be rotated in synchronization with each other.

The plurality of screw nuts 182 can be individually rotated by changing a transmission channel of the rotation transmission part 185.

For example, the rotation transmission part 185 is configured to include a gear. In this case, a driven gear is formed on an outer periphery of each of the screw nuts 182, and a driving gear is attached to an output shaft of the mold space adjustment motor 183. A plurality of the driven gears and an intermediate gear meshing with the driving gear are held to be rotatable in a central portion of the toggle support 130.

The rotation transmission part 185 may be configured to include a belt or a pulley instead of the gear.

An operation of the mold space adjustment mechanism 180 is controlled by the controller 700. The controller 700 drives the mold space adjustment motor 183, and rotates the screw nut 182. In this manner, the controller 700 adjusts the position of the toggle support 130 for holding the screw nut 182 to be rotatable with respect to a stationary platen 110, and adjusts the interval L between the stationary platen 110 and the toggle support 130.

The interval L is detected by using a mold space adjustment motor encoder 184. The mold space adjustment motor encoder 184 detects a rotation amount or a rotation direction of the mold space adjustment motor 183, and transmits a signal indicating a detection result thereof to the controller 700. The detection result of the mold space adjustment motor encoder 184 is used in monitoring or controlling the position or the interval L of the toggle support 130.

A toggle support position detector for detecting the position of the toggle support 130 and an interval detector for detecting the interval L are not limited to the mold space adjustment motor encoder 184, and a general detector can be used.

The mold space adjustment mechanism 180 adjusts the interval L by rotating one of the screw shaft 181 and the screw nut 182 which are screwed to each other. A plurality of the mold space adjustment mechanisms 180 may be used, or a plurality of mold space adjustment motors 183 may be used.

The mold clamping unit 100 of the present embodiment is a horizontal type in which the mold opening and closing direction is a horizontal direction, but may be a vertical type in which the mold opening and closing direction is an upward-downward direction.

In addition, the mold clamping unit 100 of the present embodiment has the mold clamping motor 160 as a drive source. However, a hydraulic cylinder may be provided instead of the mold clamping motor 160. In addition, the mold clamping unit 100 may have a linear motor for mold opening and closing, and may have an electromagnet for mold clamping.

### Ejector Unit

The ejector unit 200 ejects a molding product from the mold unit 10. The ejector unit 200 has an ejector motor 210, a motion conversion mechanism 220, and an ejector rod 230.

Hereinafter, in describing the ejector unit 200, as in the description of the mold clamping unit 100, a moving direction of the movable platen 120 during the mold closing (rightward direction in FIGS. 1A and 1B) will be defined as forward, and a moving direction of the movable platen 120 during the mold opening (leftward direction in FIGS. 1A and 1B) will be defined as rearward.

The ejector motor 210 is attached to the movable platen 120. The ejector motor 210 is directly connected to the motion conversion mechanism 220, but may be connected to the motion conversion mechanism 220 via a belt or a pulley.

The motion conversion mechanism 220 converts a rotary motion of the ejector motor 210 into a linear motion of the ejector rod 230. The motion conversion mechanism 220 includes a screw shaft and a screw nut screwed to the screw shaft. A ball or a roller may be interposed between the screw shaft and the screw nut.

The ejector rod 230 is freely advanced and retreated in a through-hole of the movable platen 120. A front end portion of the ejector rod 230 comes into contact with a movable member 15 disposed to be freely advanced and retreated inside the movable mold 12. The front end portion of the ejector rod 230 may be connected to or may not be connected to the movable member 15.

The ejector unit 200 performs an ejection process under the control of the controller 700.

In the ejection process, the ejector motor 210 is driven so that the ejector rod 230 is advanced from a standby position to an ejection position at a set speed. In this manner, the movable member 15 is advanced to eject the molding product. Thereafter, the ejector motor 210 is driven so that the ejector rod 230 is retreated at a set speed, and the movable member 15 is retreated to an original standby position. For example, a position or a speed of the ejector rod 230 is detected by using an ejector motor encoder 211. The ejector motor encoder 211 detects the rotation of the ejector motor 210, and transmits a signal indicating a detection result thereof to the controller 700.

An ejector rod position detector for detecting the position of the ejector rod 230, and an ejector rod speed detector for measuring the speed of the ejector rod 230 are not limited to the ejector motor encoder 211, and a general detector can be used.

### Injection Unit

The injection unit 300 is installed in slide base 301 which is freely advanced and retreated with respect to the frame Fr, and is freely advanced and retreated with respect to the mold unit 10. The injection unit 300 touches the mold unit 10, and fills the cavity space 14 inside the mold unit 10 with the molding material. For example, the injection unit 300 has a cylinder 310, a nozzle 320, a screw 330, a plasticizing motor 340, an injection motor 350, and a pressure detector 360.

Hereinafter, in describing the injection unit 300, a direction in which the injection unit 300 is moved close to the mold unit 10 (leftward direction in FIGS. 1A and 1B) will be defined as forward, and a direction in which the injection unit 300 is separated from the mold unit 10 (rightward direction in FIGS. 1A and 1B) will be defined as rearward.

The cylinder 310 heats the molding material supplied into the cylinder 310 from a feed port 311. For example, the molding material includes a resin. For example, the molding material is formed in a pellet shape, and is supplied to the feed port 311 in a solid state. The feed port 311 is formed in a rear portion of the cylinder 310. A cooler 312 such as a water-cooling cylinder is provided on an outer periphery in a rear portion of the cylinder 310. In front of the cooler 312, a heating unit 313 such as a band heater and a temperature measurer 314 are provided on the outer periphery of the cylinder 310.

The cylinder 310 is divided into a plurality of zones in an axial direction (rightward-leftward direction in FIGS. 1A and 1B) of the cylinder 310. The heating unit 313 and the temperature measurer 314 are provided in each of the zones. In each of the zones, the controller 700 controls the heating unit 313 so that a measurement temperature of the temperature measurer 314 reaches a set temperature.

The nozzle 320 is provided in a front end portion of the cylinder 310, and is pressed against the mold unit 10. The heating unit 313 and the temperature measurer 314 are provided on an outer periphery of the nozzle 320. The controller 700 controls the heating unit 313 so that a measurement temperature of the nozzle 320 reaches a set temperature.

The screw 330 is disposed to be rotatable and to be freely advanced and retreated inside the cylinder 310. When the screw 330 is rotated, the molding material is fed forward along a helical groove of the screw 330. The molding material is gradually melted by heat from the cylinder 310 while being fed forward. As the liquid molding material is fed forward of the screw 330 and is accumulated in the front portion of the cylinder 310, the screw 330 is retreated. Thereafter, when the screw 330 is advanced, the liquid molding material accumulated in front of the screw 330 is injected from the nozzle 320, and the inside of the mold unit 10 is filled with the liquid molding material.

As a backflow prevention valve for preventing a backflow of the molding material fed rearward from the front of the screw 330 when the screw 330 is pressed forward, a backflow prevention ring 331 is attached to a front portion of the screw 330 to be freely advanced and retreated.

The backflow prevention ring 331 is pressed rearward by the pressure of the molding material in front of the screw 330 when the screw 330 is advanced, and is relatively retreated with respect to the screw 330 to a close position (refer to FIG. 1B) for closing a flow path of the molding material. In this manner, the molding material accumulated in the front of the screw 330 is prevented from flowing rearward.

On the other hand, the backflow prevention ring 331 is pressed forward by the pressure of the molding material fed forward along the helical groove of the screw 330 when the screw 330 is rotated, and is relatively advanced with respect to the screw 330 to an open position (refer to FIG. 1A) for opening the flow path of the molding material. In this manner, the molding material is fed forward of the screw 330.

The backflow prevention ring 331 may be either a co-rotation type rotating together with the screw 330 or a non-co-rotation type that does not rotate together with the screw 330.

The injection unit 300 may have a drive source that advances and retreats the backflow prevention ring 331 with respect to the screw 330 between the open position and the close position.

The plasticizing motor 340 rotates the screw 330. The drive source for rotating the screw 330 is not limited to the plasticizing motor 340, and may be a hydraulic pump, for example.

The injection motor 350 advances and retreats the screw 330. A motion conversion mechanism that converts a rotary motion of the injection motor 350 into a linear motion of the screw 330 is provided between the injection motor 350 and the screw 330. For example, the motion conversion mechanism has a screw shaft and a screw nut screwed to the screw shaft. A ball or a roller may be provided between the screw shaft and the screw nut. The drive source that advances and retreats the screw 330 is not limited to the injection motor 350, and may be a hydraulic cylinder, for example.

The pressure detector 360 detects a pressure transmitted between the injection motor 350 and the screw 330. The pressure detector 360 is provided in a force transmission channel between the injection motor 350 and the screw 330, and detects the pressure acting on the pressure detector 360.

The pressure detector 360 transmits a signal indicating a detection result thereof to the controller 700. The detection result of the pressure detector 360 is used in controlling or monitoring the pressure received by the screw 330 from the molding material, a back pressure acting on the screw 330, or the pressure acting on the molding material from the screw 330.

The injection unit 300 performs a plasticizing process, a filling process, and a holding pressure process under the control of the controller 700.

In the plasticizing process, the plasticizing motor 340 is driven to rotate the screw 330 at a set rotation speed, and the molding material is fed forward along the helical groove of the screw 330. Through the process, the molding material is gradually melted. As the liquid molding material is fed forward of the screw 330 and is accumulated in the front portion of the cylinder 310, the screw 330 is retreated. For example, a rotation speed of the screw 330 is measured by using a plasticizing motor encoder 341. The plasticizing motor encoder 341 detects the rotation of the plasticizing motor 340, and transmits a signal indicating a detection result thereof to the controller 700.

A screw rotation speed detector for measuring the rotation speed of the screw 330 is not limited to the plasticizing motor encoder 341, and a general detector can be used.

In the plasticizing process, the injection motor 350 may be driven to apply a preset back pressure to the screw 330 in order to limit sudden retreat of the screw 330. The back pressure applied to the screw 330 is detected by using the pressure detector 360, for example. The pressure detector 360 transmits a signal indicating a detection result thereof to the controller 700. When the screw 330 is retreated to a plasticizing completion position and a predetermined amount of the molding material is accumulated in front of the screw 330, the plasticizing process is completed.

In the filling process, the injection motor 350 is driven to advance the screw 330 at a set speed, and the liquid molding material accumulated in front of the screw 330 fills the cavity space 14 inside the mold unit 10. The position or the speed of the screw 330 is detected by using an injection motor encoder 351, for example. The injection motor encoder 351 detects the rotation of the injection motor 350, and transmits a signal indicating a detection result thereof to the controller 700. When the position of the screw 330 reaches a set position, the filling process is switched to a holding pressure process (so-called V/P switching). The position where the V/P switching is performed will be referred to as a V/P switching position. The set speed of the screw 330 may be changed depending on the position or a time of the screw 330.

When the position of the screw 330 reaches the set position in the filling process, the screw 330 may be temporarily stopped at the set position, and thereafter, the V/P switching may be performed. Immediately before the V/P switching, instead of stopping the screw 330, the screw 330 may be advanced at a low speed, or may be retreated at a low speed. In addition, a screw position detector for detecting the position of the screw 330 and a screw speed detector for measuring the speed of the screw 330 are not limited to the injection motor encoder 351, and a general detector can be used.

In the holding pressure process, the injection motor 350 is driven to press the screw 330 forward. A pressure (hereinafter, also referred to as a “holding pressure”) of the molding material in a front end portion of the screw 330 is maintained at a set pressure, and the molding material remaining inside the cylinder 310 is pressed toward the mold unit 10. The molding material which is insufficient due to cooling shrinkage inside the mold unit 10 can be replenished. The holding pressure is detected by using the pressure detector 360, for example. The pressure detector 360 transmits a signal indicating a detection result thereof to the controller 700. A set value of the holding pressure may be changed depending on an elapsed time from the start of the holding pressure process.

In the holding pressure process, the molding material in the cavity space 14 inside the mold unit 10 is gradually cooled, and when the holding pressure process is completed, an inlet of the cavity space 14 is closed by the solidified molding material. This state is referred to as gate seal, and prevents the backflow of the molding material from the cavity space 14. After the holding pressure process, a cooling process starts. In the cooling process, the molding material inside the cavity space 14 is solidified. In order to shorten a molding cycle time, the plasticizing process may be performed during the cooling process.

The injection unit 300 of the present embodiment is an in-line screw type, but may be a pre-plastic type. The injection unit of the pre-plastic type supplies the molding material melted inside a plasticizing cylinder to an injection cylinder, and the molding material is injected into the mold unit from the injection cylinder. The screw inside the plasticizing cylinder is disposed to be rotatable or to be rotatable and freely advanced and retreated. A plunger is disposed to be freely advanced and retreated inside the injection cylinder.

In addition, the injection unit 300 of the present embodiment is a horizontal type in which the axial direction of the cylinder 310 is a horizontal direction, but may be a vertical type in which the axial direction of the cylinder 310 is an upward-downward direction. The mold clamping unit combined with the injection unit 300 of the vertical type may be the vertical type or the horizontal type. Similarly, the mold clamping unit combined with the injection unit 300 of the horizontal type may be the horizontal type or the vertical type.

### Moving Unit

The moving unit 400 advances and retreats the injection unit 300 with respect to the mold unit 10. In addition, the moving unit 400 presses the nozzle 320 against the mold unit 10, thereby generating a nozzle touch pressure. The moving unit 400 has a hydraulic pump 410, a motor 420 serving as a drive source, and a hydraulic cylinder 430 serving as a hydraulic actuator.

Hereinafter, in describing the moving unit 400, as in the description of the injection unit 300, a direction in which the injection unit 300 is moved close to the mold unit 10 (leftward direction in FIGS. 1A and 1B) will be defined as forward, and a direction in which the injection unit 300 is separated from the mold unit 10 (rightward direction in FIGS. 1A and 1B) will be defined as rearward.

The moving unit 400 is disposed on one side of the cylinder 310 of the injection unit 300 in FIGS. 1A and 1B, but may be disposed on both sides of the cylinder 310, or may be disposed symmetrically around the cylinder 310.

The hydraulic pump 410 has a first port 411 and a second port 412. The hydraulic pump 410 is a pump that can rotate in both directions, and switches rotation directions of the motor 420. In this manner, a hydraulic fluid (for example, oil) is suctioned from any one of the first port 411 and the second port 412, and is discharged from the other, thereby generating a hydraulic pressure. In addition, the hydraulic pump 410 can suction the hydraulic fluid from a tank, and can discharge the hydraulic fluid from any one of the first port 411 and the second port 412.

The motor 420 operates the hydraulic pump 410. The motor 420 drives the hydraulic pump 410 in a rotation direction and with a rotation torque in accordance with a control signal transmitted from the controller 700. The motor 420 may be an electric motor, or may be an electric servo motor.

The hydraulic cylinder 430 has a cylinder body 431, a piston 432, and a piston rod 433. The cylinder body 431 is fixed to the injection unit 300. The piston 432 partitions the inside of the cylinder body 431 into a front chamber 435 serving as a first chamber and a rear chamber 436 serving as a second chamber. The piston rod 433 is fixed to the stationary platen 110.

The front chamber 435 of the hydraulic cylinder 430 is connected to the first port 411 of the hydraulic pump 410 via a first flow path 401. The hydraulic fluid discharged from the first port 411 is supplied to the front chamber 435 via the first flow path 401. In this manner, the injection unit 300 is pressed forward. The injection unit 300 is advanced, and the nozzle 320 is pressed against the stationary mold 11. The front chamber 435 functions as a pressure chamber that generates the nozzle touch pressure of the nozzle 320 via the pressure of the hydraulic fluid supplied from the hydraulic pump 410.

On the other hand, the rear chamber 436 of the hydraulic cylinder 430 is connected to the second port 412 of the hydraulic pump 410 via a second flow path 402. The hydraulic fluid discharged from the second port 412 is supplied to the rear chamber 436 of the hydraulic cylinder 430 via the second flow path 402. In this manner, the injection unit 300 is pressed rearward. The injection unit 300 is retreated, and the nozzle 320 is separated from the stationary mold 11.

The moving unit 400 is not limited to the configuration including the hydraulic cylinder 430. For example, instead of the hydraulic cylinder 430, an electric motor and a motion conversion mechanism that converts a rotary motion of the electric motor into a linear motion of the injection unit 300 may be used.

### Controller

The controller 700 directly transmits a control signal to the mold clamping unit 100, the ejector unit 200, the injection unit 300, and the moving unit 400, and performs various controls relating to the injection molding machine 1.

The controller 700 may be realized by any hardware or a combination of any hardware and software. For example, the controller 700 is configured to mainly include a computer having a central processing unit (CPU) 701, a memory device 702, an auxiliary storage device 703, and an interface device 704 for input and output. The controller 700 performs various types of controls by causing the CPU 701 to execute a program installed in the auxiliary storage device 703. In addition, the controller 700 receives a signal from the outside or outputs a signal to the outside through the interface device 704. For example, the controller 700 is communicably connected to the management device 2 through the communication line NW based on the interface device 704. In addition, the controller 700 may be communicably connected to (the controller 700 of) the other injection molding machine 1 through the communication line NW based on the interface device 704.

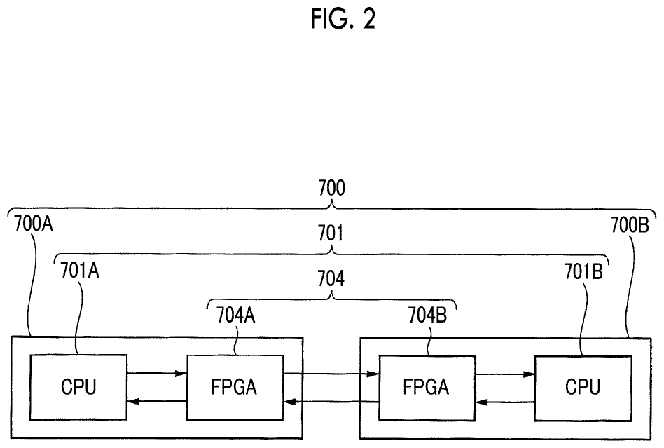

The function of the controller 700 may be realized by only one controller 700, or may be shared by a plurality of controllers (for example, host controller 700A, subordinate controller 700B, and the like) as described later (refer to FIG. 2).

The controller 700 repeatedly manufactures a molding product by causing the injection molding machine 1 to repeatedly perform a mold closing process, a mold clamping process, a mold opening process, and the like. In addition, the controller 700 causes the injection unit 300 to perform a plasticizing process, a filling process, a holding pressure process, and the like during the mold clamping process.

A series of operations for obtaining the molding products, for example, an operation from the start of the plasticizing process performed by the injection unit 300 to the start of the subsequent plasticizing process performed by the injection unit 300 is referred to as a “shot” or a “molding cycle”. In addition, a time required for one shot is referred to as a “molding cycle time”.

One molding cycle is configured to include, for example, a plasticizing process, a mold closing process, a mold clamping process, a filling process, a holding pressure process, a cooling process, a mold opening process, and an ejection process in this order. This order is an order of starting each process. In addition, the filling process, the holding pressure process, and the cooling process are performed until the mold clamping process is completed after the mold clamping process starts. In addition, the completion of the mold clamping process coincides with the start of the mold opening process.

A plurality of the processes may be simultaneously performed in order to shorten the molding cycle time. For example, the plasticizing process may be performed during the cooling process of the previous molding cycle. In this case, the mold closing process may be performed in an initial stage of the molding cycle. In addition, the filling process may start during the mold closing process. In addition, the ejection process may start during the mold opening process. In addition, in a case where an on-off valve for opening and closing the flow path of the nozzle 320 of the injection unit 300 is provided, the mold opening process may be started during the plasticizing process. The reason is as follows. Even when the mold opening process starts during the plasticizing process, when the on-off valve closes the flow path of the nozzle 320, the molding material does not leak from the nozzle 320.

The controller 700 is connected to an operation unit 750, a display unit 760, and the like.

The operation unit 750 receives an operation input relating to the injection molding machine 1 from a user, and outputs a signal corresponding to the operation input to the controller 700.

The display unit 760 displays various images under the control of the controller 700.

The display unit 760 displays, for example, an operation screen relating to the injection molding machine 1 in response to the operation input in the operation unit 750.

The operation screen displayed on the display unit 760 is used for the setting relating to the injection molding machine 1. For example, the setting relating to the injection molding machine 1 includes setting of the molding conditions (specifically, an input of a set value) relating to the injection molding machine 1. In addition, for example, the setting includes setting relating to selection of a type of a detection value of various sensors, which is recorded as logging data during the molding operation and relates to the injection molding machine 1. In addition, for example, the setting includes setting of specifications (for example, a type of an actual value to be displayed or a display method) in which the detection value (actual value) of various sensors relating to the injection molding machine 1 during the molding operation is displayed on the display unit 760. A plurality of the operation screens are prepared, and may be displayed by switching of the display unit 760, or may be displayed in an overlapping manner. A user can perform the setting (including the input of the set value) relating to the injection molding machine 1 by operating the operation unit 750 while looking at the operation screen displayed on the display unit 760.

In addition, the display unit 760 displays, for example, an information screen that provides the user with various information according to the operation on the operation screen under the control of the controller 700. A plurality of information screens are prepared, and may be displayed by switching of the display unit 760, or may be displayed in an overlapping manner. For example, the display unit 760 displays a setting content relating to the injection molding machine 1 (for example, setting content relating to the molding conditions of the injection molding machine 1). In addition, for example, the display unit 760 displays management information (for example, information relating to an actual result of the operations of the injection molding machine 1).

For example, the operation unit 750 and the display unit 760 may be configured to function as a touch panel type display, and may be integrated with each other.

Although the operation unit 750 and the display unit 760 of the present embodiment are integrated with each other, both of these may be independently provided. In addition, a plurality of the operation units 750 may be provided.

### Management Device

The management device 2 is communicably connected to the injection molding machine 1 through the communication line NW.

For example, the management device 2 is a cloud server installed in a remote location such as a management center outside a factory where the injection molding machine 1 is installed. In addition, for example, the management device 2 may be an edge server installed inside the factory or at a place relatively close to the factory where the injection molding machine 1 is installed (for example, a radio base station or a station building close to the factory). In addition, the management device 2 may be a desktop computer terminal in the factory where the injection molding machine 1 is installed. In addition, the management device 2 may be a mobile terminal (for example, a smartphone, a tablet terminal, or a laptop computer terminal) that can be carried by a manager of the injection molding machine 1.

For example, the management device 2 can identify the operation state of the injection molding machine 1 and manage the operation state of the injection molding machine 1 based on the data transmitted (uploaded) from the injection molding machine 1. In addition, the management device 2 can perform various diagnoses such as an abnormality diagnosis of the injection molding machine 1, based on the identified operation state of the injection molding machine 1.

In addition, for example, the management device 2 may transmit control information (for example, information relating to various setting conditions) to the injection molding machine 1 through the communication line NW. In this manner, the management device 2 can control the operation of the injection molding machine 1.

### Configuration Relating to Internal Communication of Injection Molding Machine

Next, the configuration relating to the internal communication of the injection molding machine 1 will be described with reference to FIG. 2.

FIG. 2 is a diagram illustrating an example of the configuration of the controller 700.

The controller 700 includes a host controller 700A and a subordinate controller 700B.

For example, the host controller 700A manages various operations (for example, molding operation) of the injection molding machine 1 and performs sequence control relating to the entire work procedure of the injection molding machine 1. Specifically, the host controller 700A may monitor the operation state of the injection molding machine 1 based on the detection data of various sensors of the injection molding machine 1, and transmit command data relating to the operation of the injection molding machine 1 (hereinafter, “operation command data”) to the subordinate controller 700B. For example, the various sensors include the mold clamping motor encoder 161, the mold space adjustment motor encoder 184, the ejector motor encoder 211, the temperature measurer 314, the plasticizing motor encoder 341, the injection motor encoder 351, the pressure detector 360, and the like.

In addition, the host controller 700A may control the collection of various data relating to the injection molding machine 1. For example, the various data include detection data of various sensors, control data such as control command data output from the subordinate controller 700B, and data equivalent to production information such as the number of shots managed by the host controller 700A, and the like.

The host controller 700A includes a CPU 701A and a field-programmable gate array (FPGA) 704A.

The CPU 701A executes various programs installed in the auxiliary storage device 703 of the host controller 700A, and realizes various functions of the host controller 700A. For example, the CPU 701A generates operation command data for each predetermined control cycle T_CTL1 and outputs the operation command data to the FPGA 704A. The output operation command data is stored in the memory of the FPGA 704A. In addition, the CPU 701A may access the memory of the FPGA 704A for each control cycle T_CTL1 and acquire the data received from the subordinate controller 700B (for example, detection data of various sensors).

The FPGA 704A communicates between the host controller 700A and an external device. For example, the FPGA 704A reads the latest operation command data in the memory for each predetermined communication cycle T_COM, and transmits the latest operation command data to an FPGA 704B of the subordinate controller 700B through the predetermined communication path. For example, the communication path between the host controller 700A (FPGA 704A) and the subordinate controller 700B (FPGA 704B) may be realized by a mutually accessible dual port memory or the like. In addition, the communication path may be realized by, for example, a local network inside the injection molding machine 1 such as Ethernet (registered trademark). In addition, the FPGA 704B may receive data (for example, detection data) transmitted from the subordinate controller 700B for each communication cycle T_COM, for example. The received data is stored in the memory of the FPGA 704A.

For example, the subordinate controller 700B performs operation control (motion control) that specifically realizes various operations (for example, molding operation) of the injection molding machine 1 under the control of the host controller 700A. Specifically, the subordinate controller 700B controls various actuators for driving a driven portion of the injection molding machine 1 so that the molding operation of the injection molding machine 1 corresponding to the operation command data is realized, based on the operation command data. The driven portion of the injection molding machine 1 includes the mold clamping unit 100, the ejector unit 200, the injection unit 300, the moving unit 400, and the like. For example, various actuators include the mold clamping motor 160, the mold space adjustment motor 183, the ejector motor 210, the plasticizing motor 340, the injection motor 350, the hydraulic cylinder 430, and the like.

In addition, the controller 700 may include a plurality of subordinate controllers 700B. For example, the subordinate controller 700B may be provided for each of a plurality of driven portions. In addition, a CPU 701B for each of the plurality of driven portions may be mounted in one subordinate controller 700B.

In addition, the subordinate controller 700B may control the operation of various actuators via a driver that controls drive of various actuators. In this case, the subordinate controller 700B outputs a control command to the driver, and the driver controls the drive of the actuator to be controlled in response to the control command received from the subordinate controller 700B.

In addition, the subordinate controller 700B may control, for example, a device that changes the state of a predetermined portion of the injection molding machine 1 to adjust the state of the predetermined portion. Specifically, the subordinate controller 700B may output a control command to the heating unit 313 based on the detection data of the temperature measurer 314 to adjust the temperature for each zone of the cylinder 310.

In addition, the subordinate controller 700B may, for example, capture (acquire) the detection data of various sensors to transmit the detection data to the host controller 700A.

The subordinate controller 700B includes the CPU 701B and the FPGA 704B.

The CPU 701B executes various programs installed in the auxiliary storage device 703 of the subordinate controller 700B, and realizes various functions of the subordinate controller 700B. For example, the CPU 701B accesses the memory of the FPGA 704B for each predetermined control cycle T_CTL2, and acquires the operation command data received from the host controller 700A. The CPU 701B may generate control commands for various actuators using the acquired operation command data to output the control commands to the various actuators.

The FPGA 704B communicates between the subordinate controller 700B and an external device. For example, the FPGA 704B receives the operation command data transmitted from the host controller 700A (FPGA 704A) for each communication cycle T_COM and stores the operation command data in the memory. In addition, the FPGA 704B may transmit a transmission request for detection data to various sensors, for example, for each communication cycle T_COM, receive the detection data transmitted from the various sensors, and store the detection data in the memory. For example, serial communication is performed between the FPGA 704B and the various sensors. In addition, the FPGA 704B may read the latest detection data in the memory, for example, for each communication cycle T_COM and transmit the detection data to the FPGA 704A of the host controller 700A through a predetermined communication path.

In the present example, the CPU 701 of the controller 700 includes the CPU 701A of the host controller 700A and the CPU 701B of the subordinate controller 700B. In addition, the interface device 704 of the controller 700 includes the FPGA 704A of the host controller 700A and the FPGA 704B of the subordinate controller 700B.

In the controller 700, the data communication time and the data usage time (that is, execution time of predetermined control using data) are synchronized so that each of the host controller 700A and the subordinate controller 700B can use the latest data received from the other.

In addition, the communication cycle T_COM is set shorter than the control cycles T_CTL1 and T_CTL2. For example, the communication cycle T_COM is set to ½ or less of the control cycles T_CTL1 and T_CTL2. In this manner, the injection molding machine 1 can perform communication between the host controller 700A and the subordinate controller 700B, or between the subordinate controller 700B and various sensors two or more times during the control cycles T_CTL1 and T_CTL2. Therefore, in the injection molding machine 1, for example, even in a case where a communication failure occurs once in two or more communications performed during the control cycles T_CTL1 and T_CTL2, and data reception cannot be completed on a receiving side, it is possible to have an opportunity to receive the same data once again.

The magnitude relationship between the communication cycle T_COM and the control cycles T_CTL1 and T_CTL2 may be realized, for example, by increasing the communication speed (for example, Gigabit Ethernet). In addition, the magnitude relationship between the communication cycle T_COM and the control cycles T_CTL1 and T_CTL2 may be realized, for example, by relatively increasing the control cycles T_CTL1 and T_CTL2, that is, by lengthening the data acquisition interval. In this manner, the frequency of hardware access to the memory of the FPGA 704A, 704B of the CPU 701A, 701B can be reduced, and the load of the CPU 701A, 701B can be reduced.

At least one of the control cycles T_CTL1 and T_CTL2 may be configured so that the user can refer to (confirm) the control cycle through the display unit 760. In addition, the same may apply to the communication cycle T_COM. For example, the controller 700 may display a screen (hereinafter, “cycle confirmation screen”) on which at least one of the control cycles T_CTL1 and T_CTL2 and the communication cycle T_COM can be confirmed in response to a predetermined operation input from the user through the operation unit 750. In this manner, the user of the injection molding machine 1 can confirm the current communication cycle T_COM and the control cycles T_CTL1 and T_CTL2, and confirm the relationship between the communication cycle T_COM and the control cycles T_CTL1 and T_CTL2 through the cycle confirmation screen.

In addition, a screen similar to the cycle confirmation screen may be displayed on a display unit provided in an external device (for example, management device 2) capable of communicating with the injection molding machine 1. In this manner, for example, the manager of the management device 2 can confirm the communication cycle T_COM and the control cycles T_CTL1 and T_CTL2 in the injection molding machine 1 to be managed from the outside, and confirm the relationship between the communication cycle T_COM and the control cycles T_CTL1 and T_CTL2.

In addition, at least one of the control cycles T_CTL1 and T_CTL2 may be configured so that the user can change the setting content. The same may apply to the communication cycle T_COM. For example, the controller 700 may display an operation screen (hereinafter, “cycle setting screen”) in which at least one setting content of the control cycles T_CTL1 and T_CTL2 and of the communication cycle T_COM can be changed in response to a predetermined operation input from the user through the operation unit 750. The cycle confirmation screen and the cycle setting screen may be common. That is, the cycle confirmation screen may be configured so that the user can confirm the setting contents of the current control cycles T_CTL1 and T_CTL2 and of the communication cycle T_COM on the cycle confirmation screen and perform an operation of changing the setting content on the cycle confirmation screen as it is. The controller 700 may change the setting contents of the control cycles T_CTL1 and T_CTL2 and of the communication cycle T_COM in response to the operation input on the cycle setting screen using the operation unit 750. In this manner, the user can intentionally change the control cycles T_CTL1 and T_CTL2 and the communication cycle T_COM through the cycle setting screen.

In addition, the controller 700 may change the setting contents of the control cycles T_CTL1 and T_CTL2 and of the communication cycle T_COM in response to a request signal from the outside (for example, management device 2). In this manner, for example, the manager of the management device 2 can change the setting contents of the control cycles T_CTL1 and T_CTL2 and of the communication cycle T_COM in the injection molding machine 1 to be managed from the outside. In this case, a setting screen similar to the cycle setting screen may be displayed on the display unit provided in the external device such as the management device 2. In this manner, for example, the manager of the management device 2 can change the setting contents of the control cycles T_CTL1 and T_CTL2 and of the communication cycle T_COM in the injection molding machine 1 to be managed through this setting screen.

In addition, the control cycles T_CTL1 and T_CTL2 may be set and changed in a direction approaching the communication cycle T_COM, that is, in a direction of shortening the communication cycle T_COM. For example, a communication standard having a significantly high communication speed such as Gigabit Ethernet may be adopted between the CPUs 701A and 701B. In such a case, the user of the injection molding machine 1 or the manager of the management device 2 can set the control cycles T_CTL1 and T_CTL2 shorter than the default setting, for example, in accordance with the significantly short communication cycle T_COM.

### Specific Example of Operation Relating to Internal Communication of Injection Molding Machine

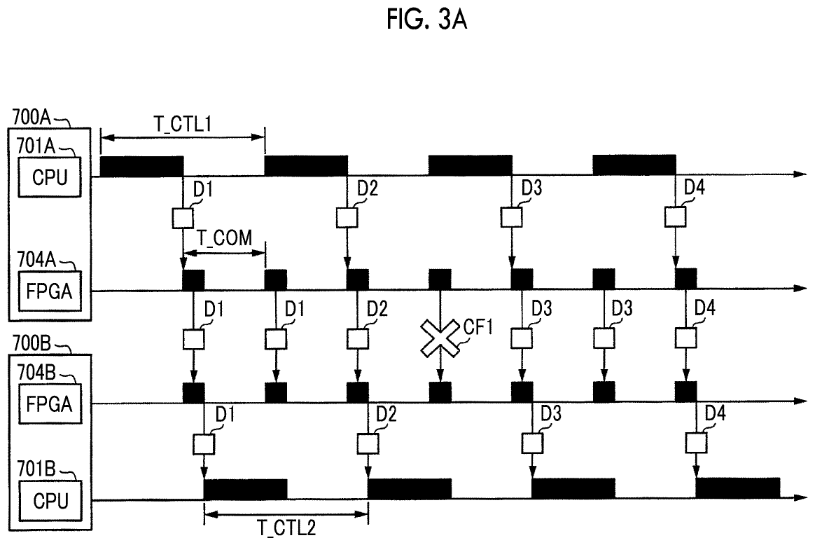

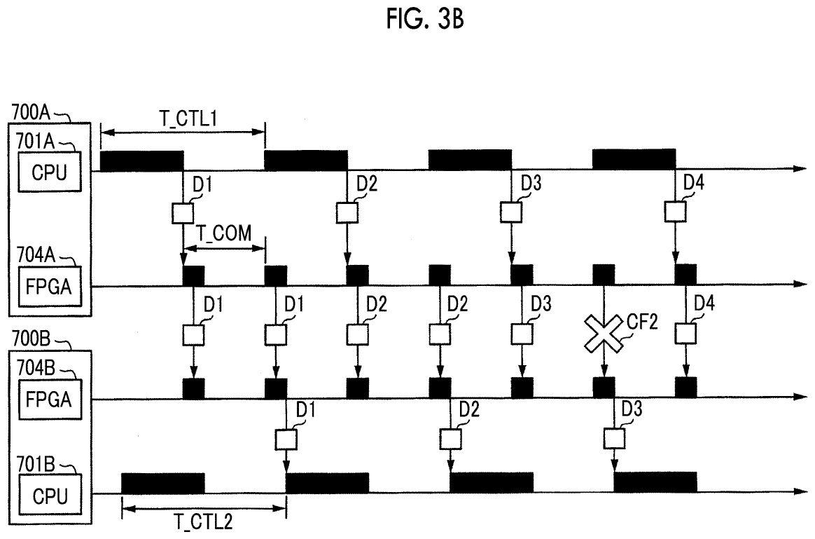

Next, a specific example of the operation relating to the internal communication of the injection molding machine 1 will be described with reference to FIGS. 3 (3A and 3B) and 4 (4A and 4B).

### Example of Controller Operation

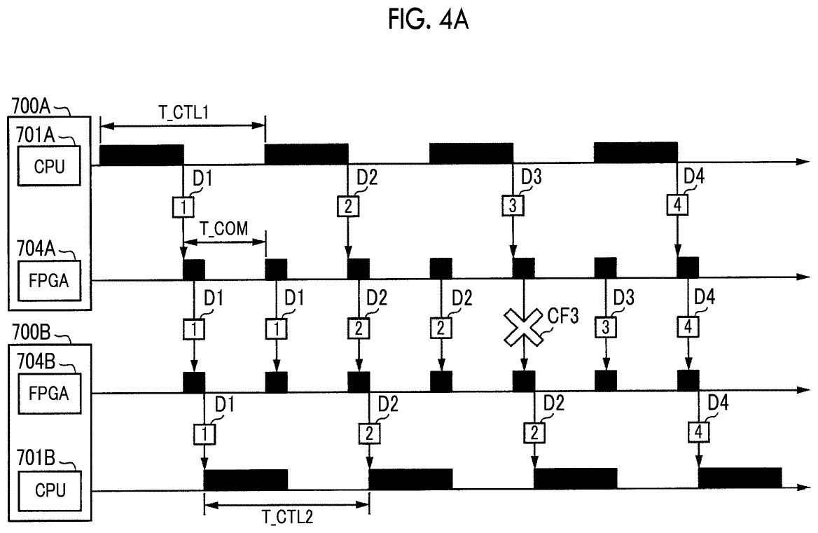

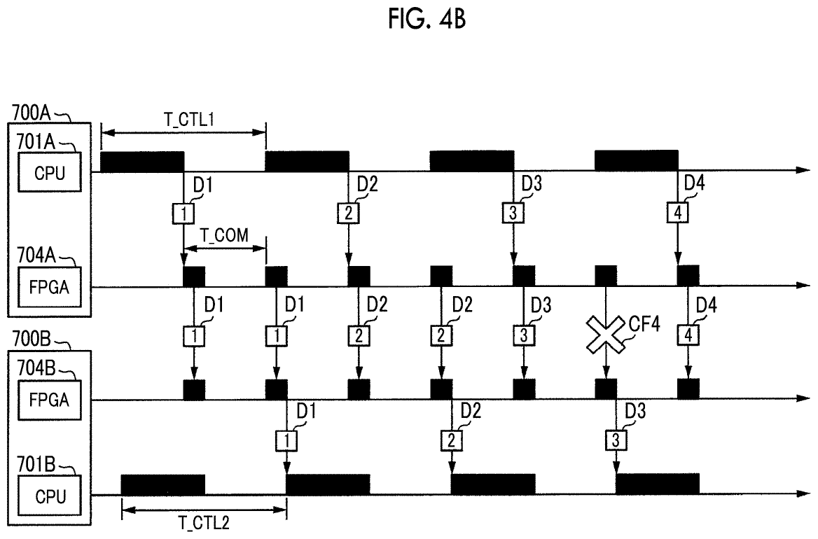

FIGS. 3A and 3B are diagrams illustrating an example of the operation of the controller 700. Black frames in the figure represent processing of the controller 700, and white frames represent the data. Hereinafter, the same applies to FIGS. 4A and 4B described later.

In FIGS. 3A and 3B, a communication delay between the host controller 700A (FPGA 704A) and the subordinate controller 700B (FPGA 704B) is ignored. Hereinafter, the same applies to cases of other examples (FIGS. 4A and 4B) described later.

As illustrated in FIGS. 3A and 3B, in the present example, in the controller 700, the control cycles T_CTL1 and T_CTL2 are set to be the same as each other, and the communication cycle T_COM is set to ½ (half) of the control cycles T_CTL1 and T_CTL2.

The CPU 701A generates data D for each control cycle T_CTL1. The data D is, for example, operation command data. In FIGS. 3A and 3B, the data D generated at different times in time-series are distinguished as data D1, D2, D3, D4 . . . . Hereinafter, the same applies to the cases of FIGS. 4A and 4B.

The FPGA 704A transmits the latest data D output by the CPU 701A to the subordinate controller 700B (FPGA 704B) for each communication cycle T_COM. Specifically, the FPGA 704A transmits the latest data D at the time immediately after the data D is output by the CPU 701A, and transmits the same data D once more before the next data D is output. In this manner, the FPGA 704A can transmit the latest data D output from the CPU 701A for each control cycle T_CTL1 to the subordinate controller 700B twice.

The FPGA 704B receives the data D transmitted from the host controller 700A (FPGA 704A) for each communication cycle T_COM. Specifically, the FPGA 704B can receive the latest data D output by the host controller 700A (CPU 701A) twice during the control cycle T_CTL2.

The CPU 701B accesses the memory of the FPGA 704B for each control cycle T_CTL2, and acquires the data D most recently received by the FPGA 704B.

In the example of FIG. 3A, the CPU 701B accesses the FPGA 704B immediately after the first time of the two times when the latest data D is received by the FPGA 704B, and acquires the data D most recently received by the FPGA 704B. In addition, in the example of FIG. 3B, the CPU 701B accesses the FPGA 704B immediately after the second time of the two times when the latest data D is received by the FPGA 704B, and acquires the data D most recently received by the FPGA 704B.

Here, in the example of FIG. 3A, a communication failure CF1 occurs at the second time of the two times when the data D2 is transmitted from the FPGA 704A to the FPGA 704B. Therefore, the FPGA 704B cannot receive the second data D2.

However, as described above, the CPU 701B acquires the data D of the memory of the FPGA 704B immediately after the first time of the two times when the FPGA 704B receives the latest data D. Therefore, even when the FPGA 704B fails to receive the data D2 at the second time, the FPGA 704B receives the updated data D3 at the next reception time, so that the CPU 701B can acquire the latest data D3 without any problem.

In addition, in the example of FIG. 3B, a communication failure CF2 occurs at the second time of the two times when the data D3 is transmitted from the FPGA 704A to the FPGA 704B. Therefore, the FPGA 704B cannot receive the second data D3.

However, the FPGA 704B has already received the first data D3, and the latest data D3 is stored in the memory as the most recently received data D. Therefore, even when the CPU 701B accesses the FPGA 704B immediately after the second time when the latest data D3 is received by the FPGA 704B, the latest data D3 received at the first time can be acquired without any problem.

As described above, in the present example, the communication cycle T_COM is set shorter than the control cycle T_CTL2. In this manner, even in a case where communication failures CF1, CF2, or the like occur, the subordinate controller 700B can perform predetermined control (for example, operation control of the driven portion based on operation command data and drive control of the actuator driving the driven portion) using the latest data D.

In addition, instead of or in addition to transmitting the data D from the host controller 700A to the subordinate controller 700B, data (for example, detection data of various sensors) may be transmitted from the subordinate controller 700B to the host controller 700A. Similarly, in this case as well, the communication cycle T_COM is set shorter than the control cycle T_CTL1. In this manner, even in a case where a communication failure or the like occurs, the host controller 700A can perform predetermined control (for example, sequence control that generates operation command data according to the work procedure and control relating to the collection of various data of the injection molding machine 1) using the latest detection data or the like.

### Other Examples of Controller Operation

FIGS. 4A and 4B are diagrams illustrating other examples of the operation of the controller 700. Hereinafter, parts different from the above example will be mainly described.

As illustrated in FIGS. 4A and 4B, in the present example, in the controller 700, similar to the case of the above example, the control cycles T_CTL1 and T_CTL2 are set to be the same as each other, and the communication cycle T_COM is set to ½ (half) of the control cycles T_CTL1 and T_CTL2.

The CPU 701A generates data D for each control cycle T_CTL1. In this case, the CPU 701A adds a counter (numbers “1”, “2”, “3”, “4” in the white frame of the data D1, D2, D3, D4 in the figure) indicating that the data D is updated to the data D. The value of the counter is incremented by one each time the data D is updated. In the present example, the counter “1” is added to the data D1, the counter “2” is added to the data D2, the counter “3” is added to the data D3, and the counter “4” is added to the data D4.

The FPGA 704A may add a counter instead of the CPU 701A.

In FIGS. 4A and 4B, the operations of FPGA 704A and FPGA 704B are the same as those in FIGS. 3A and 3B, respectively, and thus the description thereof will be omitted.

In the case of the above example, the CPU 701B accesses the memory of the FPGA 704B for each control cycle T_CTL2 and acquires the data D most recently received by the FPGA 704B.

When the CPU 701B acquires the data D, the CPU 701B compares the value of the counter of the data D acquired from the memory of the FPGA 704B last time and the value of the counter of the data D acquired from the memory of the FPGA 704B this time. In addition, only in the case where the FPGA 704B cannot receive the most recent data D, or in the situation where the FPGA 704B may not be able to receive the data D (for example, communication failure occurs), the CPU 701B may compare the values of the counters of two data D. In a case where the value of the counter of the current data D is not greater than the value of the counter of the previous data D, the CPU 701B determines that the data D stored in the memory of the FPGA 704B is not updated with the latest data D transmitted from the host controller 700A, for example, for any reason such as a communication failure. That is, the CPU 701B determines that the data D acquired this time is not the latest data D. On the other hand, in a case where the value of the counter of the current data D is greater than the value of the counter of the previous data D, the CPU 701B determines that the data D stored in the memory of the FPGA 704B is updated with the latest data D transmitted from the host controller 700A. That is, the CPU 701B determines that the data D acquired this time is the latest data D.

In a case where the data D acquired this time is the latest updated data D, the CPU 701B uses the latest data D.

For example, in the example of FIG. 4B, a communication failure CF4 occurs at the same time as that of FIG. 3B, and the FPGA 704B cannot receive the second data D3. However, as described above, the FPGA 704B has already received the first data D3, and the latest updated data D3 is stored in the memory as the most recently received data D. Therefore, even when the CPU 701B accesses the FPGA 704B immediately after the second time when the latest data D3 is received by the FPGA 704B, the latest data D3 received at the first time can be acquired without any problem. By comparing the counter “3” of the acquired data D3 with the counter “2” of the data D2 used last time, the CPU 701B can confirm that the latest data D3 has been acquired and perform predetermined control using the latest data D3.

On the other hand, in a case where the data D acquired this time is not the latest data D, the CPU 701B extrapolates the data corresponding to the latest data D based on the data D used in the past, and uses the extrapolated data.

For example, in the example of FIG. 4A, a communication failure CF3 occurs at the first time of the two times when the data D3 is transmitted from the FPGA 704A to the FPGA 704B. Therefore, the FPGA 704B cannot receive the first data D3. Therefore, the CPU 701B accesses the memory of the FPGA 704B immediately after the first reception time of the latest data D3 by the FPGA 704B, and acquires the data D2 received before the data D3.

By comparing the counter “2” of the data D2 acquired this time with the counter “2” of the data D2 used last time, the CPU 701B determines that the data D2 acquired this time is not the latest data D3. The CPU 701B extrapolates the latest data D3 by using the data D used in the past. For example, the CPU 701B may calculate the extrapolated value D3_EP of the latest data D3 using the following equation (1) corresponding to the first-order complement.

D3_EP=2×(D2−D1) (1)

In this manner, the subordinate controller 700B can supplement the latest data D from the data D used in the past even in a case where the latest data D cannot be used. Therefore, the subordinate controller 700B can improve the control performance of the injection molding machine 1 based on the data D.

As described above, in the present example, the data D transmitted from the host controller 700A to the subordinate controller 700B includes a counter indicating the presence or absence of an update of the data D. Therefore, the subordinate controller 700B can determine whether or not the data D is the latest data D in a case where the most recently received data D is used. In a case of not being the latest data D, the subordinate controller 700B can extrapolate the latest data D by using the data D used in the past.

In addition, instead of or in addition to transmitting the data D from the host controller 700A to the subordinate controller 700B, data (for example, detection data of various sensors) may be transmitted from the subordinate controller 700B to the host controller 700A. Similarly, in this case as well, by adding a counter indicating the presence or absence of an update to the transmitted data, the host controller 700A can determine whether or not the data is the latest data in a case where the most recently received data is used. In a case of not being the latest data, the host controller 700A can extrapolate the data corresponding to the latest data by using the data used in the past.

The information indicating the presence or absence of an update added to the data may be information other than the counter as long as the content changes between before and after the update.

### Specific Example of Cycle Setting Screen

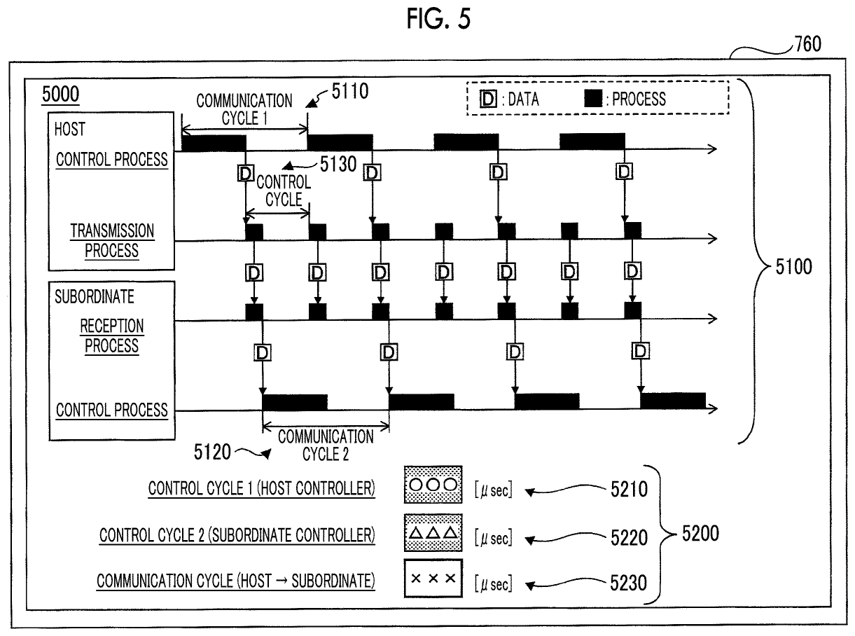

Next, a specific example of a cycle setting screen will be described with reference to FIG. 5.

FIG. 5 is a diagram illustrating an example of the cycle setting screen (cycle setting screen 5000) displayed on the display unit 760.

The cycle setting screen similar to the cycle setting screen 5000 may be displayed on a display unit provided in an external device such as the management device 2.

As illustrated in FIG. 5, the cycle setting screen 5000 includes a schematic diagram display unit 5100 and a setting state display unit 5200.

The schematic diagram display unit 5100 is disposed in a range extending from an upper end portion to a central portion in the upward-downward direction of the cycle setting screen 500. The schematic diagram display unit 5100 displays a schematic diagram (time chart) schematically illustrating processing relating to data communication between the host controller 700A and the subordinate controller 700B. In the present example, the schematic diagram display unit 5100 schematically illustrates the processing relating to data communication between the host controller 700A and the subordinate controller 700B corresponding to FIGS. 3A and 4A.

The schematic diagram (time chart) of the schematic diagram display unit 5100 illustrates sections 5110, 5120, and 5130 corresponding to each of the control cycles T_CTL1 and T_CTL2 and the communication cycle T_COM to be set.

The setting state display unit 5200 displays the current setting state of each of the control cycles T_CTL1 and T_CTL2 and the communication cycle T_COM to be set. The setting state display unit 5200 includes setting state display units 5210, 5220, and 5230 corresponding to each of the control cycles T_CTL1 and T_CTL2 and the communication cycle T_COM to be set.

In the present example, the state where the setting state display unit 5230 is selected by a cursor (thick line frame in the figure) is displayed. In this state, the user can set (change) the communication cycle T_COM by inputting and confirming a desired numerical value through the operation unit 750.

Similarly, the user may move the cursor through the operation unit 750 to transition the setting state display unit 5200 to the state where the setting state display unit 5210 or the setting state display unit 5220 is selected. The user can set (change) the control cycle T_CTL1 or the control cycle T_CTL2 by inputting and confirming a desired numerical value through the operation unit 750.

In addition, when the setting content of the communication cycle T_COM is changed through the setting state display unit 5230, the content of the schematic diagram display unit 5100 including the section 5110 may be changed according to the content of the change. Similarly, when the setting content of the control cycle T_CTL1 is changed through the setting state display unit 5220 or the setting state, the content of the schematic diagram display unit 5100 including the section 5110 may be changed according to the content of the change.

As described above, the injection molding machine 1 (controller 700) can display the cycle setting screen 5000 on the display unit 760, and cause the user to confirm the setting states of the control cycles T_CTL1 and T_CTL2 and of the communication cycle T_COM through the cycle setting screen 5000. In addition, the injection molding machine 1 can receive a request for change from the user of the control cycles T_CTL1 and T_CTL2 and of the communication cycle T_COM through the cycle setting screen 5000, and change the setting contents of the control cycles T_CTL1 and T_CTL2 and of the communication cycle T_COM. In this manner, the convenience of the user can be improved.

A screen similar to the cycle setting screen 5000 may be displayed as a cycle confirmation screen on a display unit such as the display unit 760 or the management device 2. Action

Next, the actions of the injection molding machine 1 and of the controller 700 according to the present embodiment will be described.

In the present embodiment, the communication cycle T_COM in which the data is exchanged between the host controller 700A and the subordinate controller 700B (both are examples of internal devices) is shorter than the control cycles T_CTL1 and T_CTL2 in which predetermined control is performed using the received data. For example, as described above, the predetermined control is sequence control relating to the entire work procedure of the injection molding machine 1, operation control of the driven portion of the injection molding machine 1, drive control of the actuator that drives the driven portion of the injection molding machine 1, control relating to collection of various data of the injection molding machine, or the like.

In this manner, for example, the host controller 700A and the subordinate controller 700B can have an opportunity to receive data two or more times during the control cycles T_CTL1 and T_CTL2. Therefore, for example, even when there is a failure in receiving the latest data once due to a communication failure, the host controller 700A or the subordinate controller 700B can acquire the latest data at another opportunity. That is, in the present embodiment, in a case where data is exchanged between the host controller 700A and the subordinate controller 700B and the data is used on the receiving side, the injection molding machine 1 is configured to be able to use the most recently received latest data even when there is a failure in receiving the latest data.

For example, in the injection molding machine 1, various controllers such as the host controller 700A and the subordinate controller 700B, various drivers, various sensors, and the like included in the controller 700 may be physically connected in a string of beads manner so as to be communicable. For example, this is because when various controllers and various drivers, various sensors, and the like are all connected one-to-one, the number of wirings, wiring distances, and the like may be enormous. In such a case, for example, the subordinate controller 700B needs to transmit output data from various sensors and various drivers necessary for predetermined control through a communication path connected in a string of beads. Therefore, the subordinate controller 700B takes a longer time to acquire output data at the same acquisition time from a relatively distant sensor, a driver, or the like than the time required to acquire output data from a relatively close sensor, a driver, or the like on the communication path. That is, the subordinate controller 700B or the host controller 700A having data transmitted from the subordinate controller 700B takes a relatively long time to prepare the output data of various sensors, various drivers, or the like corresponding to the same acquisition time. Therefore, in a situation like the present example, the control cycles T_CTL1 and T_CTL2 need to be set relatively long.

In such a situation, in the present embodiment, the communication cycle T_COM is set relatively short with respect to the control cycles T_CTL1 and T_CTL2 set relatively long. Therefore, in a case where the control cycle needs to be physically set to be relatively long, the injection molding machine 1 can be provided with an opportunity to exchange data two or more times during the control cycle by using the relatively long control cycle.

In addition, for example, the host controller 700A and the subordinate controller 700B may be connected by a wireless line for communication. In this case, due to the influence of noise or the like from the outside on the wireless line, the frequency of not being able to properly exchange data may be relatively higher than in the case of a wired line or the like.

On the other hand, in the present embodiment, by providing an opportunity for exchanging data two or more times during the control cycle, the controller 700 can relatively increase the probability that the receiving side can acquire the data in the two or more exchanges. Therefore, due to the influence of noise from the outside on the wireless line, the controller 700 can increase the frequency at which the receiving side can perform the predetermined control using the latest data for each control cycle in a state where the frequency of inability to exchange data properly is relatively high.

In addition, in the present embodiment, the injection molding machine 1 may perform communication for exchanging data to be periodically updated between the host controller 700A and the subordinate controller 700B a plurality of times within the data update cycle. The injection molding machine 1 may perform the predetermined control using the data received at any one of the plurality of times.

In this manner, the host controller 700A and the subordinate controller 700B can exchange the latest data a plurality of times, read the data once out of the plurality of times, and perform the predetermined control using the data. Therefore, even when there is a failure in receiving the latest data once due to a communication failure or the like, the injection molding machine 1 can acquire the latest data at another opportunity, and can suppress the opportunity for the CPU 701 to access the received data and reduce the load.

In addition, in the present embodiment, the host controller 700A and the subordinate controller 700B acquire data that is not used for the predetermined control and that has a newer content from the received data and perform the predetermined control.

In this manner, the host controller 700A and the subordinate controller 700B can acquire the latest updated data from the received data.

In addition, in the present embodiment, the data communication time and the data usage time on the receiving side are synchronized so that the latest data can be used on the receiving side of the host controller 700A and of the subordinate controller 700B. The data transmitted from at least one of the host controller 700A and the subordinate controller 700B to the other may include information indicating the presence or absence of an update.

In this manner, the host controller 700A and the subordinate controller 700B can confirm whether or not the most recently received data is updated from the data used last time.

In addition, in the present embodiment, the information relating to the presence or absence of a data update may be a counter that is counted up for each time the data is updated.

For example, in a case where a time stamp or the like is used, it is necessary to prepare a configuration for realizing the time stamp. In addition, the amount of data to be transmitted may be relatively increased, which may lead to an increase in communication load. On the other hand, in the present embodiment, it is possible to realize information relating to the presence or absence of a data update with a simple configuration and a minimum amount of data.

The counter may be in an aspect of counting down each time the data is updated.

In addition, in the present embodiment, at least one of the host controller 700A and the subordinate controller 700B may compare the information indicating the presence or absence of an update of each of the received data and the data used previously in a case where the data is used. At least one of the host controller 700A and the subordinate controller 700B may determine whether or not the most recently received data is the latest data, based on the information indicating the presence or absence of an update of each of the most recently received data and the data used previously.

In this manner, in a case where the predetermined control is performed using the data, the host controller 700A and the subordinate controller 700B can confirm whether or not the received data is the most recent data by using the information indicating the presence or absence of an update included in the data. For example, this is because in a case where the times to receive the latest data is twice or more, even when there is a failure in receiving the data once, the most recently received data may be the latest data. Therefore, the host controller 700A and the subordinate controller 700B can control the injection molding machine 1 after identifying whether or not the received data is the latest data at the time before that, in a situation where the data cannot be received at the most recent data reception time.

In addition, in the present embodiment, at least one of the host controller 700A and the subordinate controller 700B may extrapolate the data corresponding to the latest updated data based on the received data, in a case where the most recently received data is not the latest updated data.

In this manner, the host controller 700A and the subordinate controller 700B can control the injection molding machine 1 while extrapolating the latest data from the received past data in a case where the most recently received data is not the latest data. Therefore, the control performance of the injection molding machine 1 can be improved.

In addition, in the present embodiment, the display unit 760 may display at least one of the communication cycle T_COM: in which the data is exchanged between the host controller 700A and the subordinate controller 700B and the control cycles T_CTL1 and T_CTL2 in which the predetermined control is performed.

In this manner, the user of the injection molding machine 1 can confirm the setting contents of the communication cycle T_COM and of the control cycles T_CTL1 and T_CTL2. In addition, in a case where both the communication cycle T_COM and the control cycles T_CTL1 and T_CTL2 are displayed, the user can confirm the relationship between the communication cycle T_COM and the control cycles T_CTL1 and T_CTL2. Therefore, the convenience of the user can be improved.

In addition, in the present embodiment, the controller 700 may change at least one of the communication cycle T_COM in which the data is exchanged and the control cycles T_CTL1 and T_CTL2 in which the predetermined control is performed, in response to an operation input to the injection molding machine 1 or to a request signal received from the outside. In this manner, the user of the injection molding machine 1, the manager of the management device 2, and the like can intentionally change the setting contents of the communication cycle T_COM and of the control cycles T_CTL1 and T_CTL2. Therefore, it is possible to improve the convenience of the user and the like.

In addition, in the present embodiment, the injection molding machine 1 may be configured so that the control cycles T_CTL1 and T_CTL2 can be changed in a direction approaching the communication cycle T_COM.

In this manner, the user of the injection molding machine 1 or the manager of the management device 2 can set the control cycles T_CTL1 and T_CTL2 shorter than the default setting, for example, in accordance with the significantly short communication cycle T_COM. Therefore, the convenience of the user and the like can be further improved.

In addition, in the present embodiment, the configuration relating to the exchange of data between the host controller 700A and the subordinate controller 700B may be applied to the exchange of data between the controller 700 and the other device mounted on the injection molding machine 1. For example, other devices are various sensors (examples of internal devices) such as encoders, voltage sensors, current sensors, and temperature sensors. In addition, the other device may be a driver (an example of an internal device) that drives and controls an actuator that drives the driven portion of the injection molding machine 1. In addition, the configuration relating to the exchange of data between the host controller 700A and the subordinate controller 700B may be applied to the exchange of data between two CPUs 701 (an example of an internal device) built in the controller 700.

In addition, in the present embodiment, the configuration relating to the exchange of data between the host controller 700A and the subordinate controller 700B may be applied to the exchange of data between the injection molding machine 1 (controller 700) and the external device. In this case, as described above, the communication path (communication line NW) in which data is exchanged between the injection molding machine land the external device may include a 5G communication line (mobile communication network) or an Ethernet communication line corresponding to the communication standard of Gigabit Ethernet. In this manner, it possible to realize a significantly short communication cycle. For example, the external device may be the other injection molding machine 1. For example, as described above, in the plurality of injection molding machines 1, one of the injection molding machines 1 may be classified as a master machine, and the other injection molding machines 1 may be classified as slave machines, one injection molding machine 1 may control the operation states of all the injection molding machines 1 including the injection molding machine, and the molding operations of the plurality of injection molding machines 1 may be synchronized. In this case, control data may be transmitted from one injection molding machine 1 to the other injection molding machine 1, and detection data and the like of various sensors corresponding to the operation state data of the other injection molding machine 1 may be transmitted from the other injection molding machine 1 to the one injection molding machine 1. In addition, the external device may be, for example, the management device 2. For example, the plurality of injection molding machines 1 may be controlled by the management device 2, and the molding operations thereof may be synchronized. In this case, control data may be transmitted from the management device 2 to each of the plurality of injection molding machines 1, and detection data of various sensors corresponding to the operation state data may be transmitted from each of the plurality of injection molding machines 1 to the management device 2.

### Modifications and Changes

Hereinbefore, although the embodiment of the injection molding machine 1 have been described in detail, the present disclosure is not limited to the above-described embodiment, and various modifications and changes can be made within the scope of the concept described in the aspects.

For example, in the above-described embodiment, the configuration relating to the exchange of data between the internal devices of the injection molding machine 1 and between the injection molding machine 1 and the external device has been described, but similar contents may be applied to the exchange of data between internal devices of other machines and between the machine and the external device. For example, other machines are industrial machines and industrial robots used in factories. In addition, the other machine may be, for example, a work machine used at a work site (for example, an excavator, a bulldozer, a crane, and the like). That is, the configuration relating to the exchange of data between the internal devices of the injection molding machine 1 and between the injection molding machine 1 and the external device may be applied to any control system including a transmission unit and a receiving unit that exchange data, and a control unit that uses the data received by the receiving unit.

Finally, the present application claims priority based on Japanese Patent Application No. 2019-207924 filed on Nov. 18, 2019, and the entire contents of the Japanese patent application are incorporated herein by reference.

It should be understood that the invention is not limited to the above-described embodiment, but may be modified into various forms on the basis of the spirit of the invention. Additionally, the modifications are included in the scope of the invention.

What is claimed is:

1. An injection molding machine comprising:
a mold clamping unit that clamps a mold unit;
an injection unit that fills the mold unit clamped by the mold clamping unit with a molding material; and
an ejector unit that takes out a molding product from the mold unit after the molding material with which the mold unit is filled by the injection unit is cooled and solidified, wherein
a communication cycle in which data is exchanged in at least one path of between two internal devices and between the injection molding machine and an external device is shorter than a control cycle in which predetermined control is performed using received data.

2. The injection molding machine according to claim 1, wherein
the predetermined control is sequence control relating to an entire work procedure of the injection molding machine, operation control of a driven portion of the injection molding machine, drive control of an actuator that drives the driven portion of the injection molding machine, or control relating to collection of various data of the injection molding machine.

3. The injection molding machine according to claim 1, wherein
communication that exchanges the data periodically updated is performed a plurality of times within an update cycle of the data in the at least one path, and the predetermined control is performed using the data received at any one time of the plurality of times.

4. The injection molding machine according to claim 3, wherein
the data that is not used for the predetermined control and that includes a new content is acquired from the received data, and the predetermined control is performed.

5. The injection molding machine according to claim 4, wherein
a communication time of the data and a usage time of the data on a receiving side are synchronized in the at least one path, so that the latest data is capable of being used on the receiving side, and
the data includes information indicating presence or absence of an update.

6. The injection molding machine according to claim 5, wherein
the information is a counter that counts up or counts down each time the data is updated.

7. The injection molding machine according to claim 5, wherein
in a case where the data is used, it is determined whether or not the most recently received data is the latest updated data based on the information on each of the most recently received data and the data used previously.

8. The injection molding machine according to claim 1, wherein
the data is exchanged in the at least one path over a wireless line, and
the communication cycle is set so as to relatively increase a frequency at which the receiving side in the at least one path can perform the predetermined control using the latest data for each control cycle, in a state where a frequency of failure to exchange the data is relatively high due to an influence from an outside on the wireless line.

9. The injection molding machine according to claim 1, wherein
the internal devices include at least one of a combination of a host controller that manages an overall operation of the injection molding machine and a subordinate controller that performs operation control of a driven portion of the injection molding machine based on a command from the host controller, a combination of the subordinate controller and a driver that performs drive control of an actuator driving the driven portion based on a command from the subordinate controller, a combination of two CPUs built into a controller that controls the injection molding machine, and a combination of a sensor that outputs detection data and the controller that receives the detection data from the sensor.

10. The injection molding machine according to claim 1, wherein
the external device includes at least one of another injection molding machine, a terminal device, an edge server, and a cloud server.

11. The injection molding machine according to claim 1, further comprising:
a display unit that displays at least one of the communication cycle in which the data is exchanged and the control cycle in which the predetermined control is performed.

12. The injection molding machine according to claim 1, wherein
at least one of the communication cycle in which the data is exchanged and the control cycle in which the predetermined control is performed is changed in response to an operation input to the injection molding machine or to a request signal received from the outside.

13. An injection molding machine comprising:
a mold clamping unit that clamps a mold unit;
an injection unit that fills the mold unit clamped by the mold clamping unit with a molding material; and
an ejector unit that takes out a molding product from the mold unit after the molding material with which the mold unit is filled by the injection unit is cooled and solidified, wherein
in a case where data is exchanged in at least one path of between internal devices and between the injection molding machine and an external device, and predetermined control is performed using received data, even when there is a failure in receiving the data, the latest data is capable of being used.

14. A controller in which a communication cycle in which data is exchanged in at least one path of between internal CPUs and between the injection molding machine and another device is shorter than a control cycle in which predetermined control is performed using received data.
